(19) United States
(12) Patent Application Publication
(10) Pub. No.: US 2024/0013990 A1
(43) Pub. Date: Jan. 11, 2024

(54) KEY MECHANISM

(71) Applicant: Peratech Holdco Ltd, Richmond (GB)

(72) Inventors: Xu Feng, Jiansu (CN); Cao JIN, Jiansu (CN); Sun Kun, Jiansu (CN); Wei Xin, Jiansu (CN)

(21) Appl. No.: 17/919,305

(22) PCT Filed: Jun. 11, 2021
(86) PCT No.: PCT/GB2021/000069

§ 371 Date: Oct. 17, 2022

(30) Foreign Application Priority Data
Apr. 15, 2020 (CN) 2020 10297572.6
Apr. 15, 2020 (CN) 2020 20560284.0

(51) Int. Cl. H01H 13/50; H01H 13/79; G06F 3/02

(52) U.S. Cl. CPC H01H 13/503; H01H 13/79; G06F 3/0202; H01H 2231/008; H01H 2231/002; A63F 13/24

(57) ABSTRACT

A key mechanism comprises an elastic structure comprising a first cavity located above a second cavity which are spaced apart from each other. The key mechanism comprises first and second button structures. The second button structure comprises an electrode layer on an upper wall of the second cavity and an electrode layer on a lower wall of the second cavity. The second button structure has an elastic body on the surface of one of the electrode layers. The first button structure is configured to generate a first key signal when a force is applied to an upper wall of the first cavity and compress the upper wall of the second cavity upon application of that force. The electrode layers come into contact to generate a second key signal in response to elastic deformation of the elastic body when the force is applied.

### CROSS REFERENCE TO RELATED APPLICATIONS

This application claims priority from Chinese Utility Model number 202020560284.0, filed on 15 Apr. 2020 and Chinese Patent Application number 2020 10297572.6 filed on 15 Apr. 2020. The whole content of Chinese Utility Model number 202020560284.0 and Chinese Patent Application number 2020 10297572.6 is incorporated herein by reference.

### BACKGROUND OF THE INVENTION

The present invention relates to a key mechanism and a method of generating a key press signal.

Conventional computer systems for gaming are known to utilize gaming keyboards. These gaming keyboards typically trigger signals by means of film resistance, relay or capacitive mechanisms and comprise two states of open or closed. This presents a problem in that a system having only open and closed states are undesirable in gaming applications as they do not reflect the different degrees of operation in the game.

In addition, existing keyboards which are not intended for gaming applications are designed independently from gaming keyboards. Consequently, users need to purchase two separate keyboards to accommodate the differences in ordinary use and gaming use. This increases cost and is cumbersome to replace keyboards for the different uses.

### BRIEF SUMMARY OF THE INVENTION

According to a first aspect of the present invention, there is provided apparatus comprising a key mechanism and a processor, said key mechanism comprising: an elastic structure comprising a first cavity and a second cavity spaced apart from each other, said first cavity being located above said second cavity; a first button structure within said first cavity; and a second button structure, comprising: a first electrode layer disposed on an upper wall of said second cavity and a second electrode layer disposed on a lower wall of said second cavity, and a first elastic body provided on a lower surface of said first electrode layer or an upper surface of said second electrode layer; wherein: said processor is electrically connected to said first button structure, to said first electrode layer, and to said second electrode layer; and said processor is configured to: in a first mode of operation, generate a first key signal from said first button structure when a force is applied to said upper wall of said first cavity; and in a second mode of operation, generate a second key signal from said second button structure in response to elastic deformation of said first elastic body when a force is applied to an upper wall of said first cavity compressing said upper wall of said second cavity, and said first electrode layer and said second electrode layer are in contact.

According to a second aspect of the present invention, there is provided a method of generating a key press signal, comprising the steps of: obtaining an apparatus comprising a processor and a key mechanism, said key mechanism comprising a first cavity, a second cavity, a first button structure within said first cavity and a second button structure within said second cavity, and said processor being electrically connected to said first button structure and said second button structure; applying a force to an upper wall of said first cavity to generate a first key signal if said processor is in a first mode of operation; compressing said upper wall of said second cavity upon application of said force; contacting a first electrode layer and a second electrode layer of said second button structure to generate a second key signal in response to elastic deformation of a first elastic body of said second button structure, if said processor is in a second mode of operation.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows a typical scenario of an apparatus including a keyboard having a key mechanism;

FIG. 2 shows a cross-sectional schematic diagram of a key mechanism in accordance with an embodiment of the present invention;

FIG. 3 shows a schematic arrangement of two electrode layers and an elastic body responsive to an applied force;

FIG. 4 shows the embodiment of FIG. 2 in response to an application of force, such as that applied during a key press;

FIG. 5 shows a schematic diagram of the embodiment of FIG. 2 in connection with a signal generating circuit comprising a processor.

FIG. 6 shows an example electrode layer in accordance with the present invention;

FIG. 7 shows an alternative example electrode layer in accordance with the present invention;

FIG. 8 shows a cross-sectional schematic diagram of a key mechanism in a further embodiment of the present invention;

FIG. 9 shows a pressing mechanism in combination with the embodiment of FIG. 8;

FIG. 10 shows a cross-sectional schematic diagram of a key mechanism in an alternative embodiment of the present invention;

FIG. 11 shows a cross-sectional schematic diagram of a key mechanism in an embodiment of the present invention; FIG. 12 shows a cross-sectional schematic diagram of an alternative key mechanism in an embodiment of the present invention; and

FIG. 13 shows a cross-sectional schematic diagram of a further key mechanism in an embodiment of the present invention.

### DETAILED DESCRIPTION OF EMBODIMENTS OF THE INVENTION

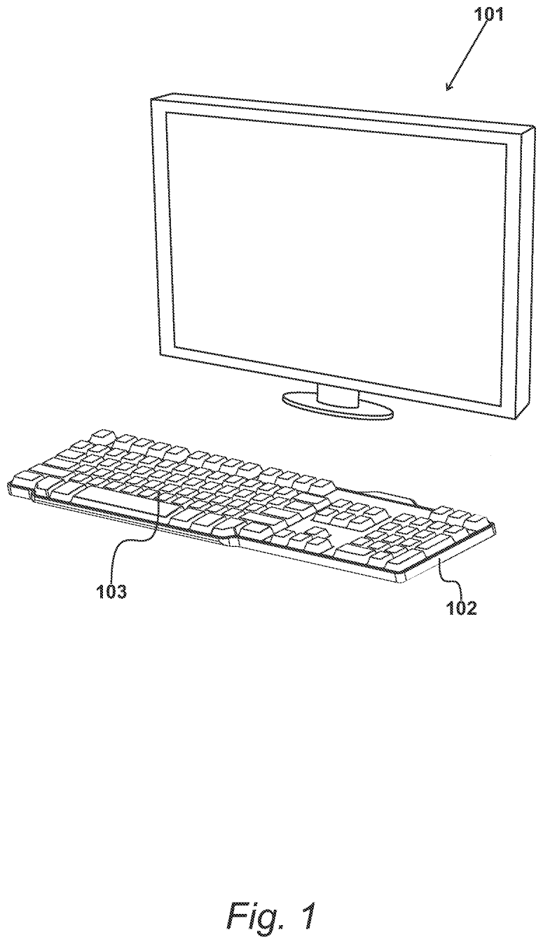

### FIG. 1

FIG. 1 shows an apparatus 101 comprising a keyboard 102. Apparatus 101 is illustrated as a desktop computer comprising a keyboard. It is appreciated that similar apparatus which comprise a keyboard may be utilized, for example, a notebook computer or personal computer or tablet having a keyboard.

In an example embodiment, game applications are configured to run on the desktop computer enabling a user to use apparatus for gaming purposes. Keyboard 102 may therefore be used to provide inputs to the personal computer, and specifically a processor or the CPU of the computer to interact with the game.

Keyboard 102 comprises a plurality of keys 103, of which each key incorporates a key mechanism in accordance with the invention. As will be described, the key mechanism of the invention provides different modes of operation and enables the keyboard to be utilized for both gaming purposes and conventional matters, thereby removing the need for separate keyboards.

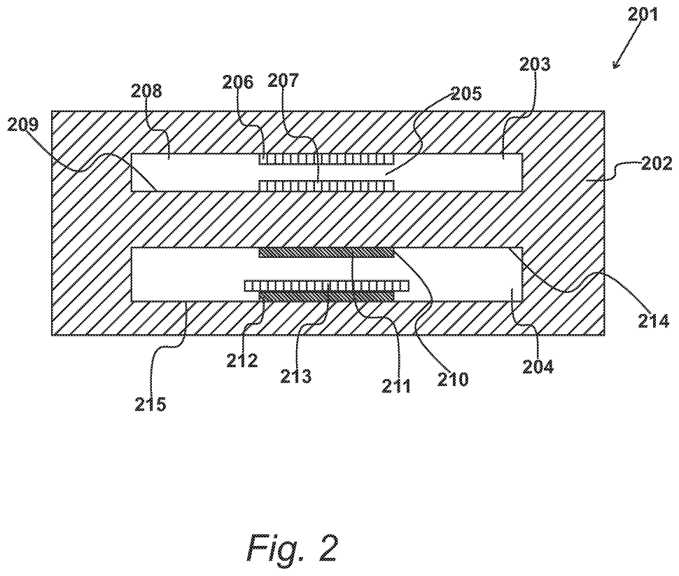

### FIG. 2

Any one of the plurality of keys 103 as shown in FIG. 1, may comprise a key mechanism of the present invention. Key mechanism 201 is shown in cross-sectional schematic view in FIG. 2 in an example embodiment of the present invention.

Key mechanism 201 comprises an elastic structure 202 formed with a first cavity 203 and a second cavity 204 which are spaced apart from each other. First cavity 203 is located above second cavity 204.

A first button structure 205 is disposed in cavity 203 and comprises electrode layer 206 and electrode layer 207. In the embodiment, electrode layer 206 is disposed on an upper wall 208 of cavity 203. Electrode layer 207 is correspondingly disposed on lower wall 209 of cavity 203.

A second button structure 210 is disposed in cavity 204 and comprises electrode layer 211, electrode layer 212 and elastic body 213. In the embodiment, electrode layer 211 is disposed on the upper wall 214 of cavity 204. Electrode layer 212 is similarly disposed on the lower wall 215 of cavity 204.

In the embodiment shown, elastic body 213 is disposed on an upper surface of electrode layer 212. In an alternative embodiment, it is appreciated that elastic body 213 is disposed on a lower surface of electrode layer 211 in a substantially similar manner.

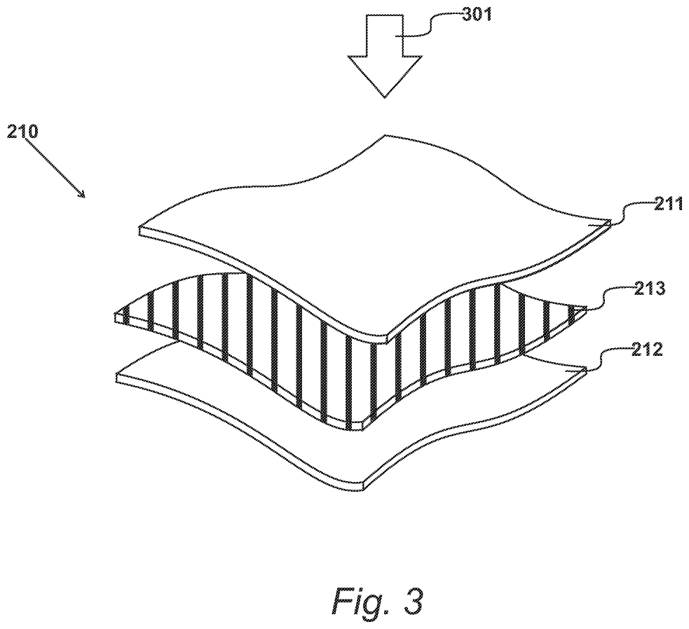

### FIG. 3

An exploded schematic of second button structure 210 is shown in FIG. 3 for illustrative purposes.

As indicated previously, button structure 210 comprises electrode layer 211, electrode layer 212 and elastic body 213.

In the embodiment, elastic body 213 may be provided on an upper surface of electrode layer 212 or the lower surface of electrode layer 211. It is appreciated that, in both cases, the function of elastic body 213 is substantially similar. In respect of the embodiments described herein, it appreciated that the elastic body 213, where shown, may be positioned in either of these positions as required.

In the embodiment, elastic body 213 comprises a carbon-based polymeric material, for example, graphene or a quantum tunnelling material such as that sold by the applicant Peratech Holdco Limited under the name QTC®.

An elastic body 213 comprising such a material is configured to exhibit a change in its own particle spacing and distribution when subjected to an external force, thereby changing from an insulator to a conductor.

Referring to the quantum tunnelling material as an example, the principle of the conductivity of an elastic body of a quantum tunnelling material is known as field-induced quantum tunnelling. Specifically, metal particles in the material are very tightly distributed in a matrix under normal conditions, but there is no direct contact between the particles. When the material is pressed or deformed, by means of an applied force 301, the distance between the metal particles is reduced to the extent that electrons can be transferred between the metal particles, thereby becoming conductive.

Once the material has become conductive in this way, the resistance value of an elastic body comprising this type of material is inversely related to the deformation or force it receives, that is, the greater the deformation or applied force, the lower the resistance measured from the elastic body. Thus, when an applied force or deformation changes continuously, the resistance will change accordingly.

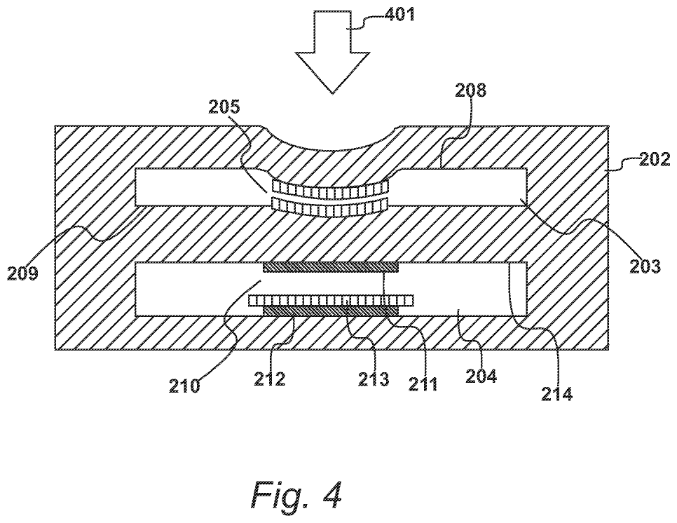

### FIG. 4

In the key mechanism described in FIGS. 2 and 3, an application of force can be applied in the manner illustrated in FIG. 4.

In the embodiment, when force 401 is applied to elastic structure 202, upper wall 208 of cavity 203 deforms such that upper wall 208 of cavity 203 moves closer to lower wall 209 of cavity 203. In response to this deformation, first button structure 205 generates a first key signal.

At the same time, as upper wall 208 of cavity 203 contacts lower wall 209 of cavity 203, lower wall 209 of cavity 203 is compressed, thereby compressing upper wall 214 of cavity 204 located opposite cavity 203. Upper wall 214 of cavity 204 therefore drives first electrode layer 211 downwards as a consequence, and first electrode layer 211 is brought into contact with second electrode layer 212.

Elastic body 213 is also compressed and consequently deformed. Following this deformation, elastic body 213 is transformed from an insulator to a conductor, and elastic body 213 outputs a resistance value which is related to the pressure (or its own deformation amount) received via force 401. After elastic body 213 is transformed into a conductive body, the first electrode layer 211 and the second electrode layer 212 connect to produce the second key signal, which is therefore related to the amount of elastic deformation of elastic body 213.

The nature of elastic body 213 and its material described with reference to FIG. 3, means that when first electrode layer 211 and second electrode layer 212 are close together and compress elastic body 213, the force is applied to elastic body 213 as a continuous change. Thus, the resistance value output is also a product of this continuous change. In this way, the second key signal generated is also a changing key signal, and the change key signal corresponds to the external force 401 exerted to the elastic structure 202.

Therefore, when a game requires different levels of operation, such as, for example, the degree of force of a character in a fighting game, the degree of speed acceleration in a driving game, the degree of force during a long jump and so on, a user can apply a force correspondingly according to the game in question.

On application of an applied force corresponding to the operation on the game keyboard in line with such examples, different forces are applied to elastic body 213 by applying different forces on the keys of the game keyboard. Applied force 401 therefore generates different second key signals to achieve different levels of operations required in the game.

Advantageously, as cavity 203 generates a first key signal through button structure 205, cavity 204 generates a second key signal which is variable in response to change in force through button structure 210. Thus, first button structure 205 generates a first key signal equivalent to a conventional keyboard having a normal opening and closing function, while second button structure 210 generates a variable second key signal in response to the change in force 401 which is equivalent to adjusting the different degrees of operation in a game. In this way, the invention provides an integration of two keyboards and saves a user additional costs while improving convenience.

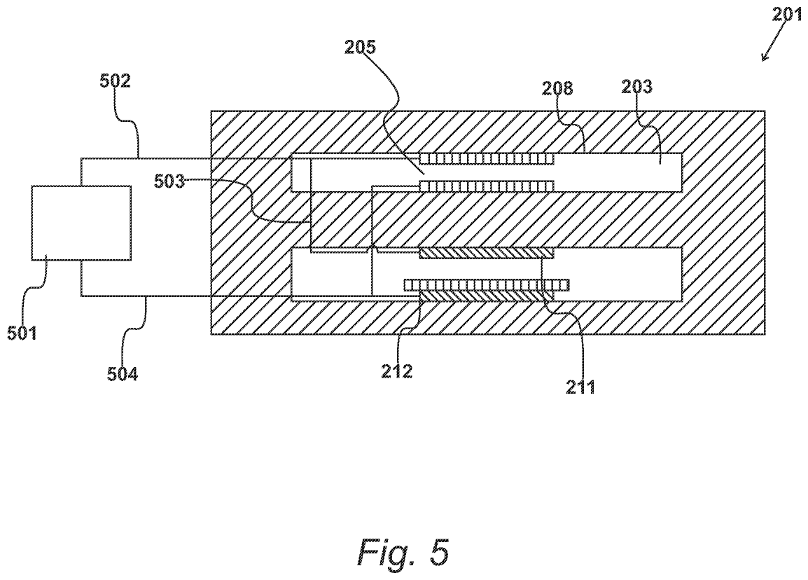

### FIG. 5

The embodiment of FIGS. 2 to 4 is illustrated further in respect to FIG. 5. In the embodiment, key mechanism 201 further comprises a key signal generating circuit comprising a processor 501 configured to generate the first and second key signals described previously.

In the embodiment, processor 501 is electrically connected to first button structure 205 by means of electrical connection 502. In addition, processor 501 is electrically connected to first electrode layer 211 and the second electrode layer 212 by means of electrical connections 503 and 504 respectively.

In a first mode of operation, when upper wall 208 of cavity 203 is pressed processor 501 generates a first key signal. In a second mode of operation, processor 501 generates a second key signal when first electrode layer 211 and second electrode layer 212 become electrically connected. In the embodiment, the first mode of operation is configured to be a normal mode and the second mode of operation is configured to be a gaming mode.

Thus, processor 501 further provides a means by which to switch between the first mode of operation and the second mode of operation. In an embodiment, switching between the normal mode and the game mode is achieved by a set button connected to processor 501. In the normal mode of operation, processor 501 is configured to only receive the first key signal generated and transmitted by the first button structure 205. In the game mode of operation, processor 501 is configured to only receive the second key signal transmitted from second button structure 210 generated from first electrode layer 211 and second electrode layer 212.

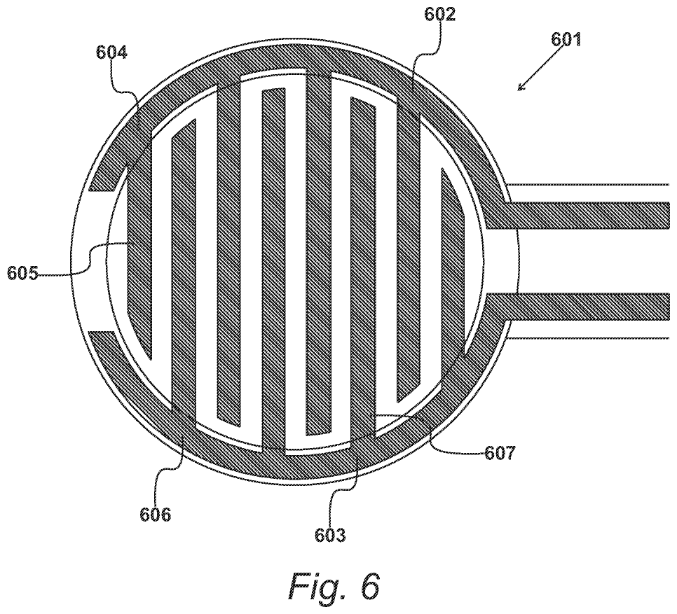

### FIG. 6

In an embodiment, electrode layer 211 takes a form substantially similar to that as illustrated in FIG. 6. It is appreciated that, in other embodiments, any one of the electrode layers may take a form substantially similar to that as depicted in FIG. 6 as necessary.

In the embodiment, electrode layer 601 comprises a plurality of first interdigitated fingers 602 and a plurality of second interdigitated fingers 603. The plurality of first interdigitated fingers 602 are spaced apart from the plurality of second interdigitated fingers 603. Additionally, the plurality of first interdigitated fingers 602 are arranged substantially opposite the plurality of second interdigitated fingers 603 and are alternately spaced.

In the embodiment, each finger of the plurality of first interdigitated fingers 602 is connected to a first main electrode 604 such that the fingers 605 extend from main electrode 604. Similarly, each finger of the plurality of second interdigitated fingers 603 is connected to a second main electrode 606 such that the fingers 607 extend from main electrode 606.

In the embodiment, first main electrode 604 and second main electrode 606 are arranged opposite to each other and each plurality of interdigitated fingers 605, 607 are arranged alternately in sequence. The plurality of first interdigitated fingers 605 and plurality of second interdigitated fingers 607 are located between main electrode 604 and main electrode 606. A first end of each finger 605 is connected to main electrode 604 and a first end of each finger 607 is connected to main electrode 606.

In this embodiment, the shapes of the first main electrode 604 and the second main electrode 606 are substantially arc-shaped and form a circular arrangement into which the plurality of first interdigitated fingers and plurality of second interdigitated fingers are located.

In the embodiment where electrode layer 211 is configured in the manner of electrode layer 601, the plurality of first interdigitated fingers 602 are positioned on the upper wall of cavity 204. In this embodiment, when the upper wall 214 of cavity 204 is pressed thereby driving each of the plurality of interdigitates fingers downwards, both pluralities of interdigitated fingers deform elastic body 213. As indicated previously, elastic body 213 changed from an insulator to a conductive body, such that the plurality of first interdigitated fingers and the plurality of second interdigitated fingers are connected to electrode layer 212 to create a current flow and complete the circuit.

It is noted that, since the particle spacing and distribution change of elastic body 213 may be different in the horizontal and vertical directions, when the particle spacing and distribution change in the vertical direction, the electron transfer path is in order—from the plurality of first interdigitated fingers to elastic body 213 to electrode layer 212 to the plurality of second interdigitated fingers. When the particle spacing and distribution are changed to the lateral direction, the electron transfer path is instead transferred inside the first electrode layer 211, which in turn is: plurality of first interdigitated fingers to elastic body 213 to plurality of second interdigitated fingers 603.

Thus, by utilizing the design of this embodiment, elastic bodies with different particle distributions can be adapted to different application to enable increased adaptability of the key mechanism.

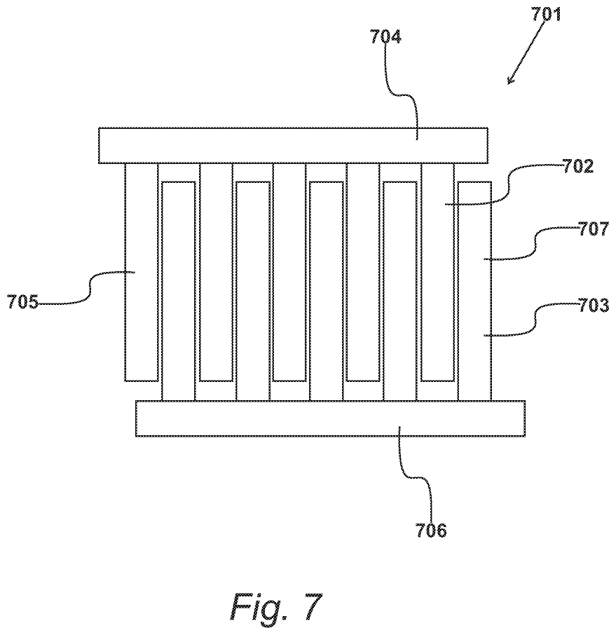

### FIG. 7

An alternative structural arrangement to the embodiment of FIG. 6 is shown in FIG. 7. FIG. 7 shows an alternative electrode layer 701 which is functionally similar to the embodiment of FIG. 6.

In the embodiment, electrode layer 701 comprises a plurality of first interdigitated fingers 702 and a plurality of second interdigitated fingers 703. The plurality of first interdigitated fingers 702 are spaced apart from the plurality of second interdigitated fingers 703. Additionally, the plurality of first interdigitated fingers 702 are arranged substantially opposite the plurality of second interdigitated fingers 703 and are alternately spaced.

In the embodiment, each finger of the plurality of first interdigitated fingers 702 is connected to a main electrode 704 such that the fingers 705 extend from main electrode 704. Similarly, each finger of the plurality of second interdigitated fingers 703 is connected to a second main electrode 706 such that the fingers 707 extend from main electrode 706.

In the embodiment, main electrode 704 and main electrode 706 are substantially rectangular in cross section and arranged in parallel to each other.

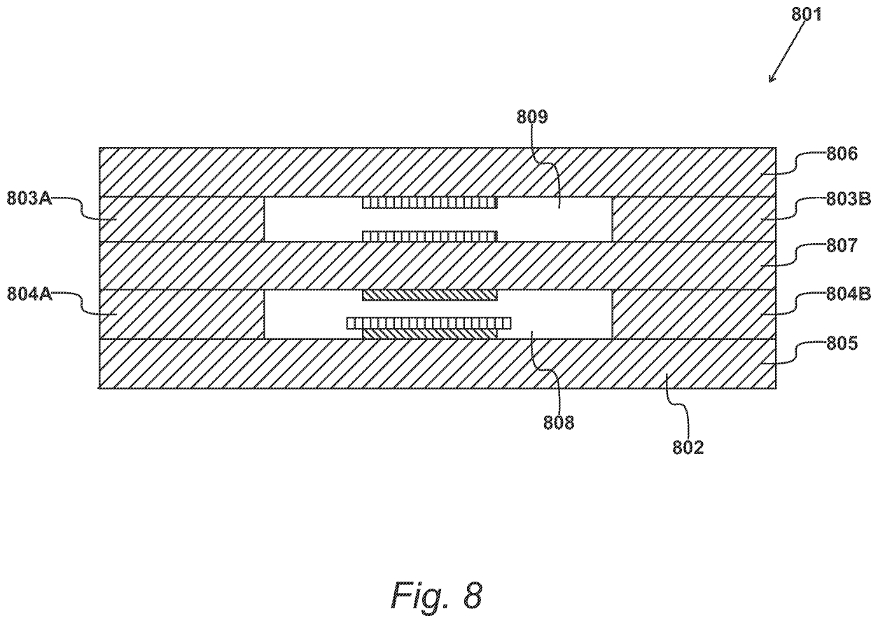

### FIG. 8

In an alternative implementation of a key mechanism will now be shown in respect of FIG. 8. In addition to the features described previously, which may be substantially similar to key mechanism 201, key mechanism 801 differs as follows.

Key mechanism 801 comprises an elastic structure 802. In this embodiment, elastic structure 802, unlike the one-piece elastic structure of FIG. 2, comprises a plurality of structural layers. Thus, elastic structure 802 comprises support structure 803, support structure 804, base layer 805, elastic membrane 806 and elastic membrane 807.

Elastic membrane 807 is disposed above base layer 805 with support structures 804 therebetween. In this way, support structure 804 and elastic membrane 807 defines cavity 808 on base layer 805.

Elastic membrane 806 is disposed above elastic membrane 807 and separated by support structures 803 such that support structure 803, elastic membrane 806 and elastic membrane 807 define cavity 809.

In a similar manner to previous embodiments, cavity 809 comprises two electrode layers and cavity 808 comprises two electrode layers and an elastic body. It is appreciated that these layers are substantially similar to the embodiment of key mechanism 201 and function in a substantially similar way as described previously.

In the embodiment, when elastic membrane 806 is subjected to an external pressing force, elastic membrane 806 is deflected in response to the external pressing force, and the lower surface of the wall of elastic membrane 806 will deform downwards. In this way, the upper wall and lower wall of cavity 809—that is, the upper surface of elastic membrane 807, are brought in contact with each other to generate the first key signal. The lower surface of elastic membrane 807 opposite the upper surface of elastic membrane 807 is also compressed. The pressure then drives the first electrode layer located on the upper wall of cavity 808 to move substantially downwards, and the elastic body deforms thereby generating a second key signal related to the amount of deformation of the elastic body.

In the embodiment, support structures 804 and the support structures 803 may be two in number and opposed and aligned with each other in the manner illustrated. In an alternative embodiment, support structures 804 and support structures 803 may also be positioned in an alternative manner and not opposite to each other.

In an embodiment, support structures 803 and support structures 804 may be independent components and may comprise support members such as rubber blocks. Alternatively, support structures 803 and support structures 804 may not be independent components.

In an embodiment support structure 803 and support structure 804 may comprise a colloid material. In an embodiment, in order to connect base layer 805, elastic membrane 806, and elastic membrane 807 to the colloid, enough colloid can be used to form the support structures such that a cavity is defined between the base layer 805 and elastic membrane 807.

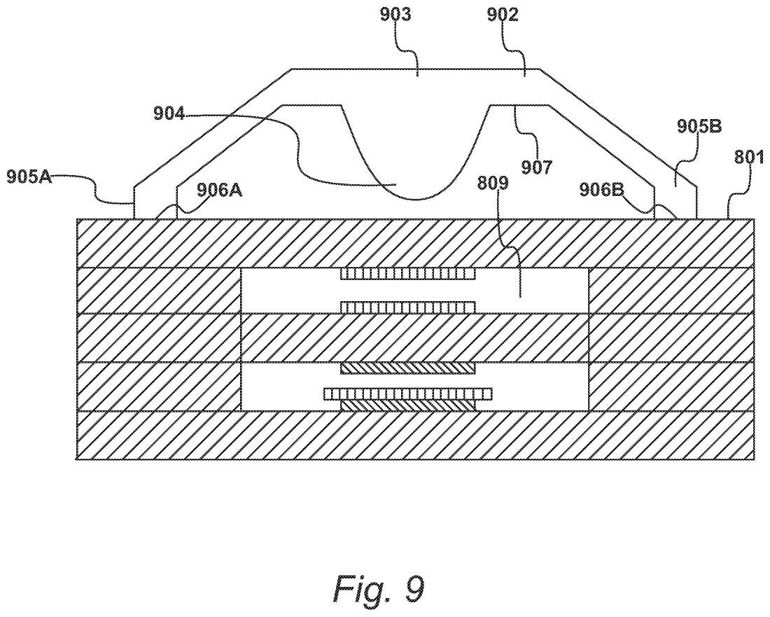

### FIG. 9

In the embodiment shown in FIG. 8, key mechanism 801 further comprises a pressing mechanism in the manner which will be described in FIG. 9. It is appreciated that the pressing mechanism illustrated in respect of

FIG. 9 is not limited to the embodiment of FIG. 8 and may also be applied to the embodiment of FIG. 2 and key mechanism 201.

Key mechanism 801 comprises a pressing mechanism 902, which comprises a pressing member 903, an abutting member 904, and two support members 905.

Support members 905 are connected to a lower surface of pressing member 903 at a respective first end of each support member as shown. The support members 905 are spaced apart from each other and are arranged on opposite sides relative to cavity 809 at a second end 906.

Abutting member 904 is arranged on a lower surface 907 of pressing member 903 and located between the two support members 905. Abutting member 904 is positioned substantially opposite cavity 809 so as to enable compression the upper wall of cavity 809.

Thus, a user can press pressing member 903 of pressing mechanism 902 to apply a force to pressing member 903, and the two support members 906 connected to pressing member 903 deform so as to move pressing member 903 and abutting member 904 in a downwards fashion, such that abutting member 904 gradually approaches the upper wall of cavity 809. Under application of a certain force, abutting member 904 contacts and consequently moves the upper wall of cavity 809 under pressure, thereby generating a first key signal and a second key signal in the manner previously described herein.

In an embodiment, pressing member 903, abutting member 904, and two support members 905 comprise elastic materials, and the shape of abutting member 904 comprises a smooth curved surface. In an embodiment, abutting member 904 is substantially cone-shaped.

In addition to the structure described above, it is appreciated that the pressing mechanism 902 may comprise other structures provided it enables a force to be exerted on the upper wall of cavity 809 when the user applies a force, and it can be restored when a user releases that force.

In a further embodiment, support members 905 may not use elastic materials and instead comprise support members comprising springs. In this embodiment, the springs are configured to contract when pressed and rebound when pressing is withdrawn to prompt the pressing members and abutting members to return to their original shapes.

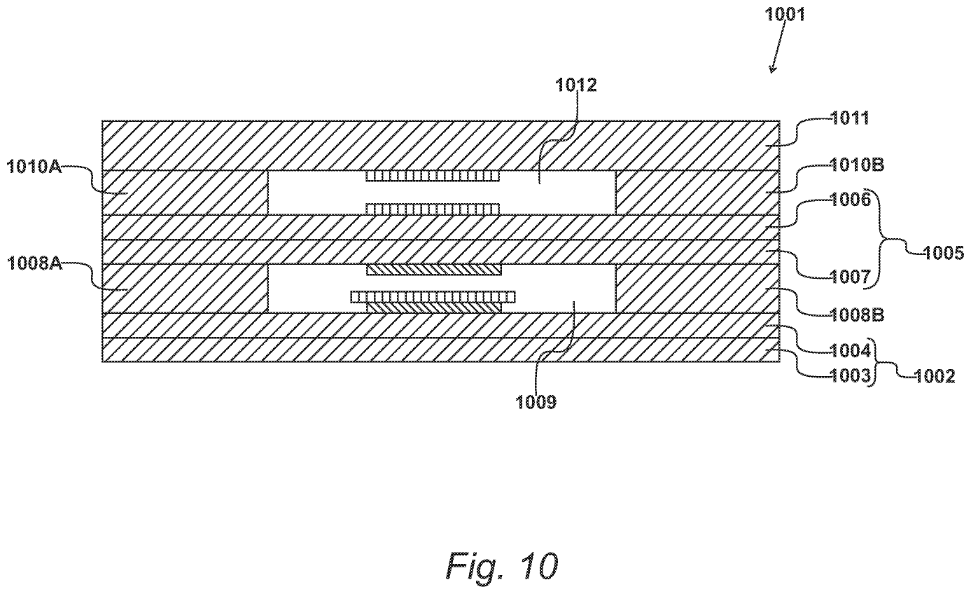

### FIG. 10

Further implementations of embodiments as alternatives to the previous embodiments described will now be described with respect to FIGS. 10 to 13. It is appreciated that these embodiments may include substantially similar features to previous embodiments where not explicitly stated as otherwise. It is further appreciated that alternative arrangements comprising a combination of embodiments are also applicable.

FIG. 10 shows a key mechanism 1001 which is similar to the embodiment of FIG. 8. However, in this embodiment base layer 1002 comprises a substrate 1003 and an elastic membrane 1004. Elastic membrane 1004 is disposed on substrate 1003 and support structures 1008 are disposed on elastic membrane 1004 at intervals.

Elastic membrane 1005 comprises an elastic upper layer 1006 and an elastic lower layer 1007. Elastic lower layer 1007, support structures 1008 and elastic membrane 1004 form cavity 1009. Elastic upper layer 1006 is arranged on an upper surface of elastic lower layer 1007 and support structures 1010 are arranged on elastic upper layer 1006 at intervals. Elastic membrane 1011, support structures 1010 and elastic upper layer 1006 form cavity 1012.

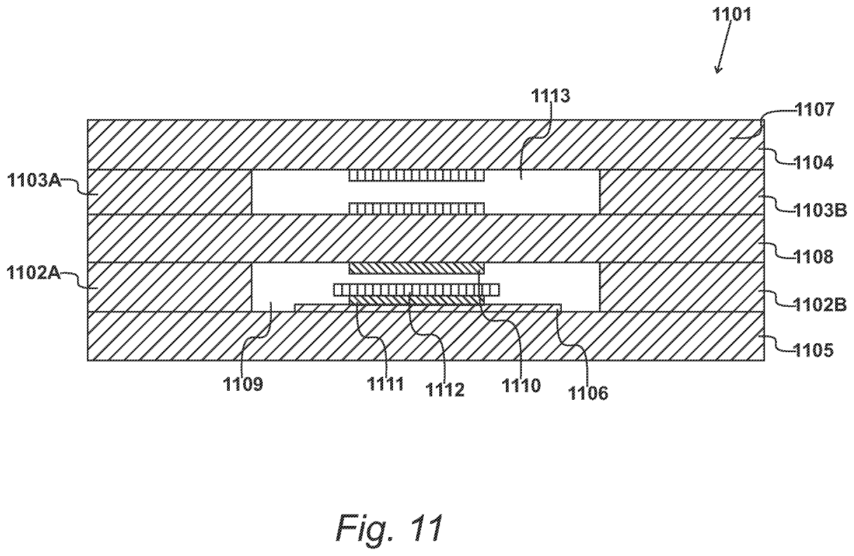

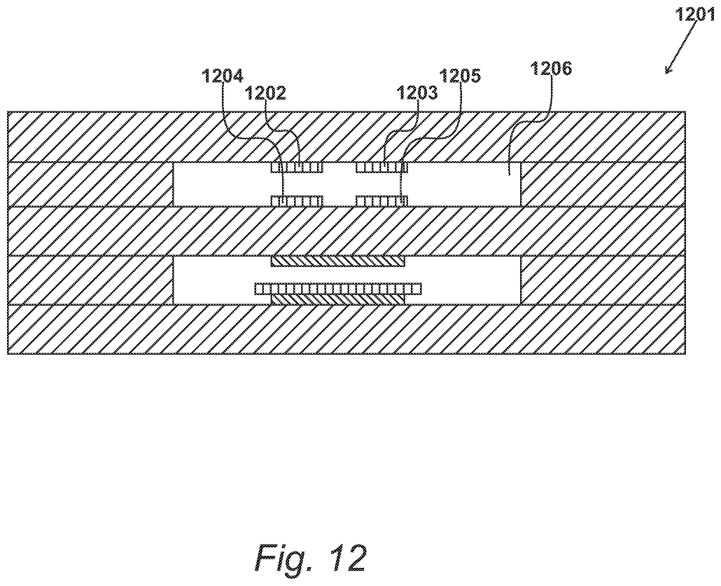

### FIG. 11

A further embodiment of a key mechanism 1101 is shown in FIG. 11.

In the embodiment, key mechanism 1101 comprises support structures 1102 and support structures 1103. Elastic structure 1104 comprises a metal base 1105, an insulating layer 1106, elastic membrane 1107 and elastic membrane 1108.

Elastic membrane 1108 is arranged on metal base 1105 via two support structures 1102 positioned therebetween. Support structures 1102 and elastic membrane 1108 define cavity 1109 with the metal base 1105. Insulating layer 1106 is disposed on a lower wall of cavity 1109.

Electrode layers 1110 and 1111 are disposed on the upper wall of cavity 1109 and insulating layer 1106 respectively. Elastic membrane 1107 is arranged above elastic membrane 1108 via support structures 1103 therebetween. Support structures 1103, elastic membrane 1107 and elastic membrane 1108 define cavity 1113.

In this embodiment, when the base layer or substrate is made of metal, an insulating layer can be added between the electrode layer 1111 and metal base 1105 to prevent problems such as leakage from the key mechanism.

### FIG. 12

A further embodiment of a key mechanism 1201 is shown in FIG. 12. Key mechanism 1201 comprises a third electrode layer in addition to cases where the upper and lower electrodes are described in previous embodiments.

Thus, key mechanism 1201 comprises electrode layer 1202, electrode layer 1203, electrode layer 1204, and electrode layer 1205. Electrode layer 1202 and electrode layer 1203 are spaced apart on the upper wall of cavity 1206. Electrode layer 1204 and electrode layer 1205 are arranged on a lower wall of cavity 1206 and spaced apart in a substantially similar manner. Electrode layer 1202 and electrode layer 1204 are arranged substantially opposite to each other, and electrode layer 1203 and electrode layer 1205 are arranged substantially opposite to each other.

In this example of a first button structure, the upper wall of cavity 1206 is driven by an applied external force to move electrode layer 1202 and electrode layer 1203 downwards during application, so that electrode layer 1202 and opposite electrode layer 1204 is in contact thereby conducting. Similarly, electrode layer 1203 and opposite electrode layer 1205 come in contact and conduct.

In this embodiment, when one of the upper and lower pair of electrodes fails, the other pair of electrodes can still generate the first key signal, which increases the fault tolerance rate of the key module.

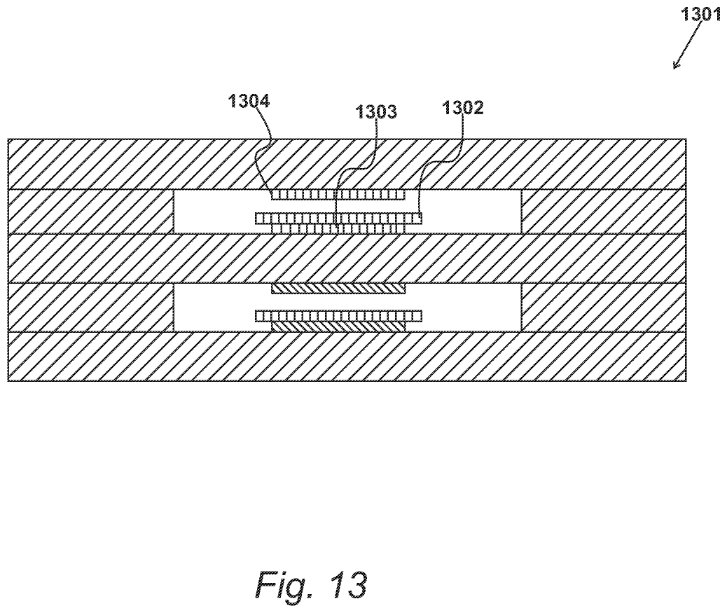

### FIG. 13

A further embodiment of a key mechanism 1301 is shown in FIG. 13. Key mechanism 1301 differs from previous embodiments in that it further comprises a further elastic body 1302. Elastic body 1302 may comprise a substantially similar material as that as described previously in FIG. 3.

In the embodiment, elastic body 1302 is disposed on the upper surface of electrode layer 1303. It is appreciated that, in a further embodiment, elastic body 1302 may equally be disposed on the lower surface of electrode layer 1304.

In this way, a user's ability to adjust by force changes during the key press process in the first mode of operation can be effectively increased.

The embodiments herein thereby provide a key mechanism to solve the problem that existing gaming keyboards usually only have two states of open and closed and therefore cannot provide different levels of operations in the game. The embodiments also provide a means in which the variable force applied to the keys in a gaming keyboard is recognized and the solutions provide a single keyboard which functions both for ordinary or normal use, as well as gaming use. Thus, a user does not need to buy two separate keyboards or replace the keyboard for different applications.

1. Apparatus comprising a key mechanism and a processor, said key mechanism comprising:
an elastic structure comprising a first cavity and a second cavity spaced apart from each other, said first cavity being located above said second cavity;
a first button structure within said first cavity; and
a second button structure, comprising:
a first electrode layer disposed on an upper wall of said second cavity and a second electrode layer disposed on a lower wall of said second cavity, and
a first elastic body provided on a lower surface of said first electrode layer or an upper surface of said second electrode layer;
wherein:
said processor is electrically connected to said first button structure, to said first electrode layer, and to said second electrode layer; and
said processor is configured to:
in a first mode of operation, generate a first key signal from said first button structure when a force is applied to an upper wall of said first cavity; and
in a second mode of operation, generate a second key signal from said second button structure in response to elastic deformation of said first elastic body when a force is applied to said upper wall of said first cavity compressing said upper wall of said second cavity, and said first electrode layer and said second electrode layer are in contact.

2. The apparatus of claim 1, wherein said first electrode layer comprises a plurality of first interdigitated fingers and a plurality of second interdigitated fingers.

3. The apparatus of claim 2, wherein said plurality of first interdigitated fingers and said plurality of second interdigitated fingers are arranged substantially opposite to each other and alternately spaced.

4. The apparatus of claim 2, wherein each of said plurality of first interdigitated fingers is connected to a first main electrode, and each of said plurality of second interdigitated fingers is connected to a second main electrode.

5. The apparatus of claim 4, wherein said first main electrode and said second main electrode are substantially arc-shaped and form a circular arrangement into which said plurality of first interdigitated fingers and said plurality of second interdigitated fingers are located.

6. The apparatus of claim 4, wherein said first main electrode and said second main electrode are substantially rectangular and are arranged in parallel to each other.

7. The apparatus of claim 1, wherein:
said first button structure comprises a third electrode layer and a fourth electrode layer; and
said third electrode layer is disposed on said-an upper wall of said first cavity and said fourth electrode layer is disposed on a lower wall of said first cavity.

8. The apparatus of claim 7, further comprising a second elastic body disposed on a lower surface of said third electrode layer or an upper surface of said fourth electrode layer, arranged such that, in use, when a force is applied to said upper wall of said first cavity, said third electrode layer contacts said fourth electrode layer to generate said first key signal in response to elastic deformation of said second elastic body.

9. The apparatus of claim 1, wherein said elastic structure comprises:
a base layer, a first support structure, a second support structure, a first elastic membrane and a second elastic membrane.

10. The apparatus of claim 9, wherein said first support structure is arranged between said second elastic membrane and said base layer such that said first support structure, said second elastic membrane and said base layer define said second cavity.

11. The apparatus of claim 9, wherein said second support structure is arranged between said first elastic membrane and said second elastic membrane such that said second supporting structure, said first elastic membrane and said second elastic membrane define said first cavity.

12. The apparatus of claim 1, further comprising:
a pressing mechanism, said pressing mechanism comprising a pressing member, an abutting member, and two support members.

13. The apparatus of claim 12, wherein said two support members are connected to a lower surface of said pressing member at a respective first end of each said support member; and
said two support members are arranged on opposite side walls of said first cavity at a respective second end of each said support member; and
said abutting member is arranged on said lower surface of said pressing member and located between said two support members, such that, said abutting member is opposite to said first cavity so as to enable compression of said upper wall of said first cavity.

14. The apparatus of claim 1, wherein said processor is configured to switch between said first mode of operation and said second mode of operation.

15. A method of generating a key press signal, comprising the steps of:
obtaining an apparatus comprising a processor and a key mechanism,
said key mechanism comprising a first cavity, a second cavity, a first button structure within said first cavity and a second button structure within said second cavity, and
said processor being electrically connected to said first button structure and said second button structure;
applying a force to an upper wall of said first cavity to generate a first key signal when said processor is in a first mode of operation;
compressing an upper wall of said second cavity upon application of said force; and
contacting a first electrode layer and a second electrode layer of said second button structure to generate a second key signal in response to elastic deformation of a first elastic body of said second button structure, when said processor is in a second mode of operation.

16. (canceled)
